(19) United States
(12) Patent Application Publication
(10) Pub. No.: US 2003/0109176 A1
(43) Pub. Date: Jun. 12, 2003

(54) Electric connector with screw rods

(76) Inventor: Chou Hsuan Tsai, Hsin-Chuang City (TW)

Correspondence Address: PRO-TECHTOR INTERNATIONAL, 20775 Norada Court, Saratoga, CA, 95070-3018, US

(21) Appl. No.: 10/292,983

(22) Filed: Nov. 12, 2002

(30) Foreign Application Priority Data
Dec. 6, 2001 (TW) 090221433

(51) Int. Cl. H01R 13/648

(52) U.S. Cl. 439/607

(57) ABSTRACT

An electric connector includes a base formed with a through hole, a plurality of terminals arranged within the base, a metal housing covering a front end of the base and fixed to the base, at least one screw rod including a threaded section and an engagement section. Each of the terminals has one end protruding out of the base. The metal housing is formed with a through hole corresponding to the through hole of the base. The engagement section is fixed to the base after penetrating through the through holes of the metal housing and the base. The through hole of the metal housing is formed with a first engagement surface, while the engagement section of the screw rod is formed with a first engagement surface. The screw rod and the through hole are engaged with each other by the first engagement surfaces to avoid rotation therebetween.

### BACKGROUND OF THE INVENTION

1. Field of the Invention

The invention relates to an electric connector, and in particular to an electric connector with screw rods.

2. Description of the Related Art

In general, an electric connector having a projecting front end for fitting includes a metal housing covering a plastic projection of the connector to protect the projection. In addition, in order to screw another connector to the electric connector after the projection is covered, screw rods are provided at two sides of the projection. Consequently, the screw rods may be screwed to achieve firmly connection between the two connectors.

Referring to FIGS. 1 and 2, a conventional electric connector includes a base 10, a metal housing 16, two screw rods 20 and two metal insertions 26.

The base 10 is provided with a plurality of terminals 11, each of which extending out of the base. The base 10 has a front end formed with a projection 12 and through holes 13 formed at two sides of the base.

The metal housing 16 covers the projection 12 of the base 10 and is formed with through holes 17 corresponding to the through holes 13 of the base. The through holes 17 are formed with engagement features 18.

The metal insertions 26 are mounted to two sides of the base 10 and are formed with through holes 27, respectively.

Each of the screw rods 20 has a threaded section 21 and an engagement section 22. The surface of the engagement section 22 is rolled to form embossments 23. The engagement section 22 penetrates through the through holes 17, 13 and 27 of the metal housing, base and metal insertion and then is fixed. On the other hand, the threaded section 21 is formed with a screw hole 24.

The above-mentioned screw rods 20 engage with the engagement features 18 of the metal housing 16 using the embossments 23 so as to prevent the screw rods 20 from rotating.

There are some drawbacks in the above-mentioned structure. Since the embossments 23 of the screw rods are formed by way of rolling, the heights of the embossments are limited. Thus, when the embossments engage with the engagement features 18 of the metal housing, the engagement forces are not strong and cannot meet the requirement of high torsional forces. This is because the embossments 23 may be worn out when the screw rods are screwed on the metal housing using great forces.

### SUMMARY OF THE INVENTION

An object of the invention is to provide an electric connector with screw rods to improve the engagement forces between the metal housing and the screw rods. Therefore, the requirement of high torsional forces may be satisfied.

To achieve the above-mentioned object, the invention provides an electric connector including a base formed with a through hole, a plurality of terminals arranged within the base, a metal housing covering a front end of the base and fixed to the base, at least one screw rod including a threaded section and an engagement section. Each of the terminals has one end protruding out of the base. The metal housing is formed with a through hole corresponding to the through hole of the base. The engagement section is fixed to the base after penetrating through the through holes of the metal housing and the base. The through hole of the metal housing is formed with a first engagement surface, while the engagement section of the screw rod is formed with a first engagement surface. The screw rod and the through hole are engaged with each other by the first engagement surfaces to avoid rotation therebetween.

According to the above-mentioned structure, the metal housing and the screw rod may be firmly fastened to meet the requirement of high torsional forces.

### BRIEF DESCRIPTION OF THE DRAWINGS

FIG. 1 is a pictorially exploded view showing a conventional electric connector having screw rods.

FIG. 2 is a front view showing the metal housing of the conventional electric connector.

FIG. 3 is a pictorially exploded view showing an electric connector having screw rods according to a first embodiment of the invention.

FIG. 4 is a pictorial view showing the electric connector according to the first embodiment of the invention.

FIG. 5 is a pictorially exploded view showing an electric connector according to a second embodiment of the invention.

FIG. 6 is a pictorially exploded view showing an electric connector according to a third embodiment of the invention.

FIG. 7 is a pictorially exploded view showing a screw rod according to a fourth embodiment of the invention.

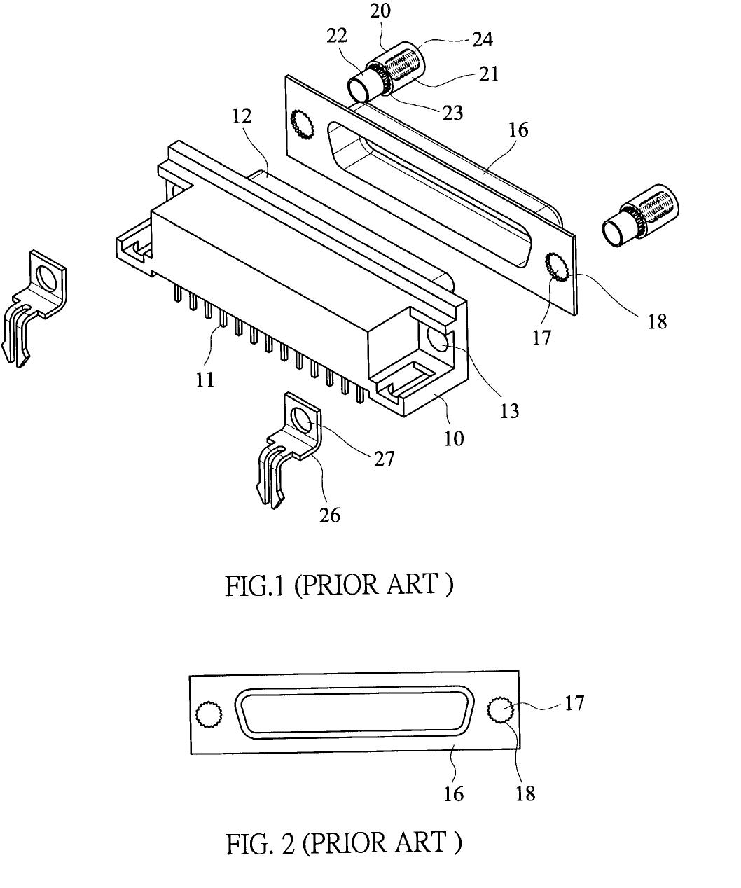

### DETAILED DESCRIPTION OF THE INVENTION

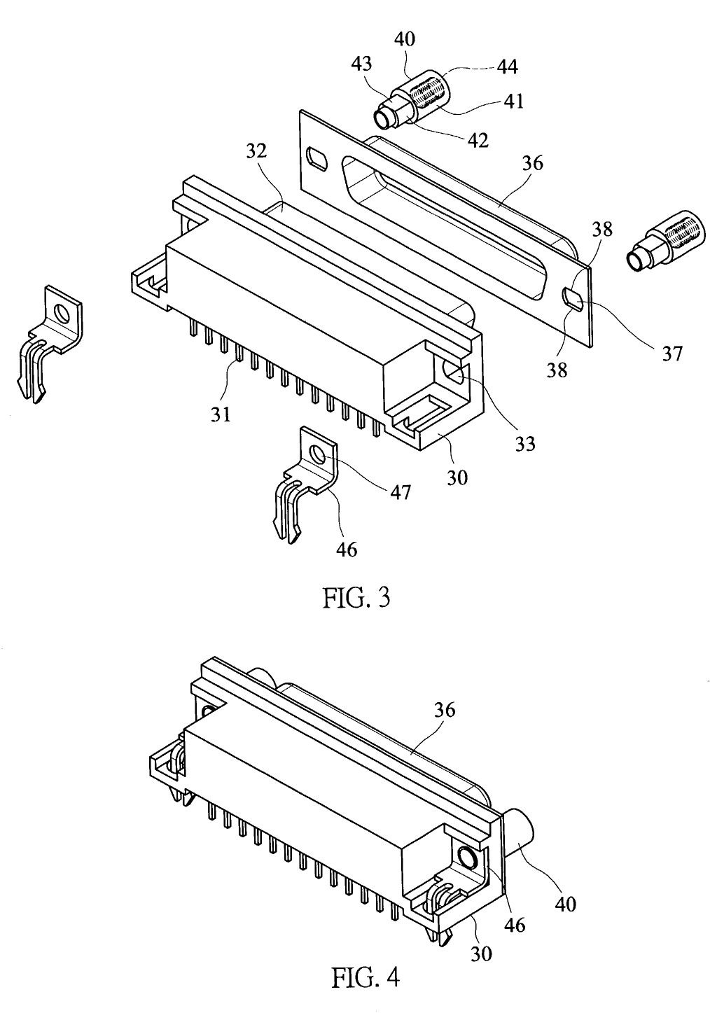

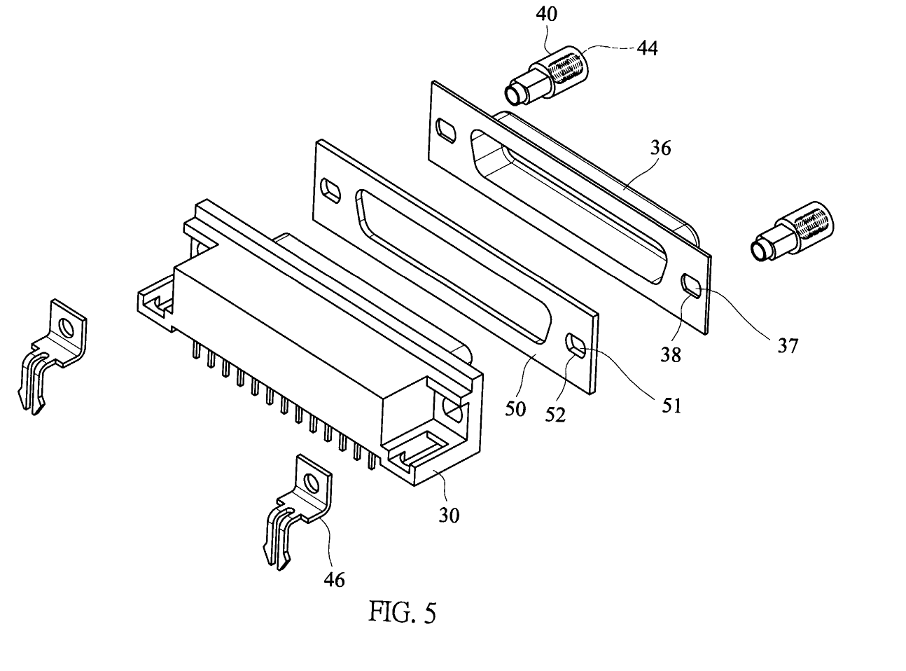

Referring to FIGS. 3 and 4, an electric connector according to one embodiment of the invention includes a base 30, a metal housing 36, two screw rods 40 and two metal insertions 46.

The base 30 is provided with a plurality of terminals 31, each of which extending out of the base. The base 30 has a front end formed with a projection 32 and through holes 33 formed at two sides of the base 30.

The metal housing 36 covers the projection 32 of the base 30 and is formed with through holes 37 corresponding to the through holes 33 of the base. Each of the through holes 37 is formed with two engagement surfaces 38.

Two metal insertions 46 are mounted to two sides of the base 30 and formed with through holes 47, respectively.

Each of the screw rods 40 has a threaded section 41 and an engagement section 42. Two engagement surfaces 43 are formed on the engagement section 42. The engagement section 42 penetrates through the through holes 37, 33 and 47 of the metal housing, base and metal insertion and then is fixed. On the other hand, the threaded section 41 is formed with a screw hole 44.

According to the above-mentioned structure, the engagement surfaces 43 of the screw rod 40 may fit with the engagement surfaces 38 of the through hole 37 of the metal housing so as to prevent the screw rod 40 from rotating. Because the thickness of the metal housing 36 may be limited, the metal housing may be heat-treated to improve its intensity. Accordingly, the metal housing may bear greater torsional forces without deformation.

The metal insertions 46 may be inserted into the circuit board and also grounded simultaneously

FIG. 5 shows an electric connector according to a second embodiment of the invention. The difference between the second and first embodiments resides in that a reinforced plate 50 is added in the second embodiment. The reinforced plate 50 is formed with two through holes 51 corresponding to the through holes 37 of the metal housing 36. Each of the through holes 51 also has two engagement surfaces 52 corresponding to the engagement surfaces 38 of the through holes 37. Using the reinforced plate 50, the combination intensity between the screw rods and the base 30 may be enhanced. In this embodiment, the metal housing 36 and the reinforced plate 50 need not to be heat-treated.

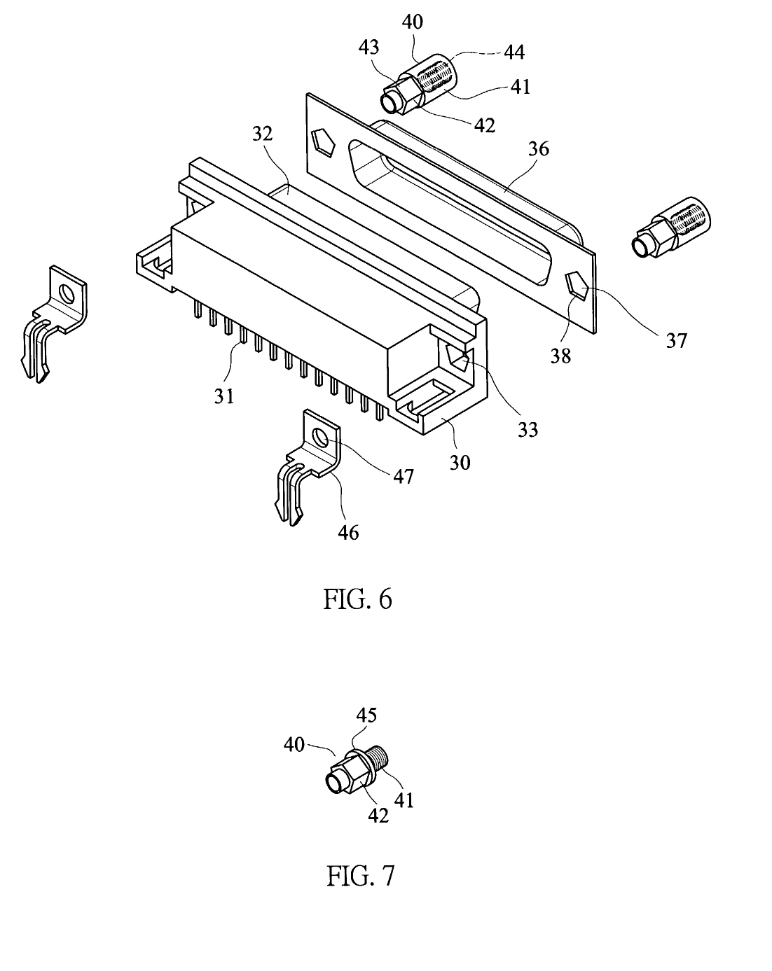

FIG. 6 shows an electric connector according to a third embodiment of the invention. The difference between the third and first embodiments resides in that the number of engagement surfaces 38 of the through hole 37 of the metal housing 36 is five in the third embodiment. In addition, the number of engagement surfaces 43 of the engagement section 42 of the screw rod 40 is also five.

Similarly, the numbers of engagement surface(s) of the screw rod 40 and the metal housing 36 may be one, three, four, six, and the like without disabling the engagement effect.

FIG. 7 shows a screw rod according to a fourth embodiment of the invention. The difference between the fourth and the third embodiments resides in that the threaded section 41 of the screw rod 40 is formed with male threads and a wider washer 45 is provided between the threaded section 41 and the engagement section 42 in the fourth embodiment. The washer 45 may contact the periphery of the through hole 37 of the metal housing.

While the invention has been described by way of example and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An electric connector, comprising:
a base formed with at least one through hole;
a plurality of terminals arranged within the base, each of the terminals having one end protruding out of the base;
a metal housing covering a front end of the base and fixed to the base, the metal housing being formed with at least one through hole corresponding to the at least one through hole of the base;
at least one screw rod including a threaded section and an engagement section, which is fixed to the base after penetrating through the at least one through hole of the metal housing and the at least one through hole of the base, wherein:
the at least one through hole of the metal housing is formed with a first engagement surface;
the engagement section of the at least one screw rod is formed with a first engagement surface; and
the at least one screw rod and the at least one through hole of the metal housing are engaged with each other by way of the first engagement surfaces to avoid rotation therebetween.

2. The electric connector according to claim 1, wherein:
the at least one through hole of the metal housing is further formed with a second engagement surface;
the engagement section of the at least one screw rod is further formed with a second engagement surface; and
the at least one screw rod and the at least one through hole of the metal housing are engaged with each other by way of the first and second engagement surfaces to avoid rotation therebetween.

3. The electric connector according to claim 1, further comprising a metal insertion, wherein the engagement section of the at least one screw rod is fixed to the base after penetrating through the at least one through hole of the metal housing, the at least one through hole of the base and the metal insertion.

4. The electric connector according to claim 1, wherein the threaded section of the at least one screw rod is formed with a screw hole.

5. The electric connector according to claim 1, wherein the threaded section of the screw rod is formed with male threads.
